(19) United States
(12) Patent Application Publication
(10) Pub. No.: US 2021/0086359 A1
(43) Pub. Date: Mar. 25, 2021

(54) Efficient Programming of Robots for Processing Workpieces with Different Variants

(71) Applicant: Convergent Information Technologies GmbH, Haid (AT)

(72) Inventors: Christof Eberst, Munich (DE); Bernhard Stöffler, Piberbach (AT); Gerhard Umgeher, Pucking (AT); Massimo Ferri, Reda (PL); Christian Feurer, Linz (AT)

(21) Appl. No.: 16/634,025

(22) PCT Filed: Jul. 27, 2018
(86) PCT No.: PCT/EP2018/070499

§ 371 Date: Jan. 24, 2020

(30) Foreign Application Priority Data
Jul. 27, 2017 (EP) 17183552.3

(51) Int. Cl. B25J 9/16

(52) U.S. Cl. CPC B25J 9/1666; B25J 9/1671

(57) ABSTRACT

A method is described for the computer-aided programming of robots for processing workpieces. According to one exemplary embodiment, the method comprises the generation of a first virtual workpiece by superposing models of several workpiece variants of a workpiece by means of a software tool run on a workstation and the carrying out of path planning for defining tool paths for at least one first region of the workpiece and verifying the defined tool paths on the basis of the first virtual workpiece. Each of the workpiece variants is given by a set of determined local geometric forms of a basic body. The different geometric forms can be formed for example by attachment parts arranged on the workpiece basic body or by modification of the external geometric shape of the workpiece basic body.

### TECHNICAL FIELD

The present invention regards the computer-supported (automatic and semiautomatic) programming of robots, for example, robots for measuring or processing (painting, polishing, welding, sealing joints, etc.) of workpiece surfaces having numerous different geometric variants.

### BACKGROUND

One task of robots in manufacturing consists in the automated processing of workpiece surfaces (e.g. painting, polishing, grinding and similar processes, etc.). For the programming of these tasks, executable robot programs are generated, by means of off-line programming or “Teach-in” or other methods of “Programming by Demonstration”, that can be implemented by a robot controller. A robot program describes commands that can be processed by the robot controller and transformed by the same into corresponding control signals for the robot and for the tools used by the robot (e.g. spray guns for painting, polishing or grinding tools, etc.), thus effecting that the robot carries out the programmed movements and actions required to complete the desired processing of the workpiece surface.

Teach-in methods for programming robots are increasingly being replaced by semi- and fully automatic software tools that run, e.g. on a workstation and which can generate and simulate (and validate) a robot program off line. The simulations can encompass the entire robot cell (that is, the robot, the workpiece, and the workplace of the robot) and the simulations entail both the movements of the robot as well as the manner in which the robot is to carry out the respective task. This carrying-out the task (for example, painting the surface of the workpiece) by the robot will be referred to as process in the following. The results of the process (for example, the thickness of a layer of paint applied during the process) can also be simulated using the aforementioned software tools.

One of the first steps in the computer-supported (automatic or semiautomatic) programming of robots is the path planning, i.e. the planning of the trajectory (position and orientation) of the tool center point (TCP) of the robot and with this the planning of the trajectory of the tool used by the robot. A trajectory may be comprised of numerous path segments, which can be determined automatically or semi-automatically by the computer (i.e. computer-based, but with the additional assistance of a person who can intervene in the planning) on the basis of a CAD model of the workpiece.

Known computer-based methods for automatic path planning generate a robot program for workpieces that makes use of specific geometry (geometric shape). In some applications, workpieces can be represented in numerous different manifestations/variants of a given basic shape. These different variants of a basic shape may arise, for example, when different parts of a base body (e.g. a chassis) have different geometric characteristics. The different geometric characteristics result, for example, from different versions of add-on components. This means, for example, that different combinations of add-on components—depending on the variant—may be mounted on a base body (e.g. a chassis). For example, depending on the variant, tractors, semitrailers or trailers will have different fuel tanks, air tanks, axels, stowage spaces, additional modules, etc. If it is assumed that there is a given number N of various add-on components and a given number of versions V exist for each add-on component (e.g. large, medium, small), then there will be as many as (V+1)^{N} variants of the basic shape of the workpiece. (V+1 because an add-on component can either be attached in one of the Versions, or it cannot be attached at all.)

Different variants of a basic shape may also arise, for example, when workpieces of different categories are manufactured (e.g. in a long or short version of a trailer, with counterweights of various numbers and sizes, having frames of various sizes, etc.). In the different categories, parts or regions of a workpiece may be similar (outwardly or where it is relevant to the process) or parts/regions of the workpiece may be similar or identical but are arranged on different positions on the workpiece (e.g. when the workpieces have different lengths). Further variants of a basic shape may arise from a so-called “facelift”, in which case the workpieces to be processed are similar to earlier workpieces in certain aspects and are only new or different in some other aspects. Differing product generations of the same workpiece may also differ, if only minimally, and can also be regarded as different variants of the same workpiece.

When known methods for the computer-assisted planning of robot paths are employed to generate robot programs, a separate path planning has to be carried out and a corresponding robot program has to be generated (as well as simulated and validated) for every single workpiece. When the programming task is divided into segments, for example, or when some of the results are reused for other variants, the planning may take a considerable amount of time, especially in the case of workpieces that have a complex geometry that does not allow the path planning to be carried out fully automatically but instead requires that a person manually intervenes in the planning process and, in particular, when a robot program that was determined fully automatically or interactively needs to be optimized before or after execution. The inventor recognized this problem and one goal of the present invention consists in efficiently programming—and optimizing—many (or, at best, even all) of the variants with as little effort as possible. In particular in the first case (entailing numerous versions of different add-on components), programs will have to be made available to the robots for many (e.g. thousands) possible workpiece variants (variants of combinations of the add-on components). Because of the subsequent optimization of the robot programs that is often required, not only should as many variants as possible be covered by each program with as little programming or planning effort as possible, but the given variants should also be covered by as few programs as possible (at best only as many as are absolutely required) and the variants themselves should be processed in as few different tool paths (requiring optimization) as possible.

### SUMMARY

The aforementioned objective is achieved by means of the method in accordance with claim 1. Various embodiments and further developments form the subject matter of the dependent claims.

A method for the computer-assisted programming of robots for processing workpieces is described. In accordance with one embodiment, the method comprises generating a first virtual (not necessarily implementable) workpiece by virtually superposing models of numerous variants of a workpiece employing a software tool executed on a workstation, as well as carrying out a path planning to determine the tool paths for at least one first region of the workpiece and verifying the determined tool paths based on the first virtual workpiece. Each one of the workpiece variants is defined by a number of specific, local and geometric manifestations of a basic body. The various geometric manifestations can be formed, for example, by add-on components on the base body of the workpiece or by modifications of the outer geometric shape of the base body of the workpiece. Further, a corresponding system for the (partially) automated, computer-assisted programming is described.

### SHORT DESCRIPTION OF THE FIGS.

The invention will be described in greater detail based on the examples illustrated in the figures. The illustrations are not necessarily true to scale and the invention is not limited to the aspects illustrated here. Instead importance is given to illustrating the underlying principles of the invention. The figures show:

FIG. 1 illustrates the formation of a maximal model by superposing the CAD data of various workpiece variants.

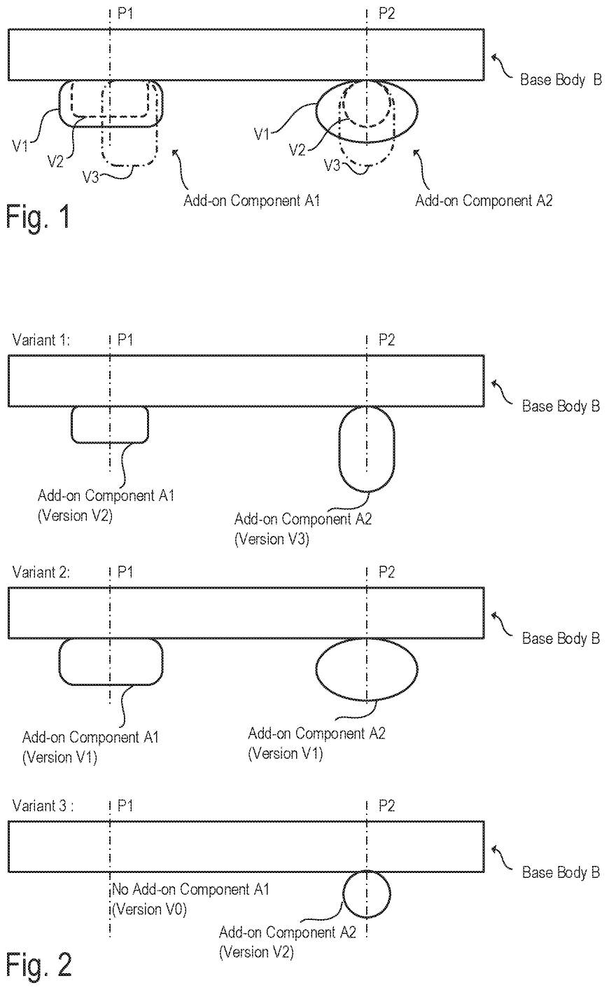

FIG. 2 illustrates examples of three different specific workpiece variants that contribute to the formation of the maximal model in accordance with FIG. 1.

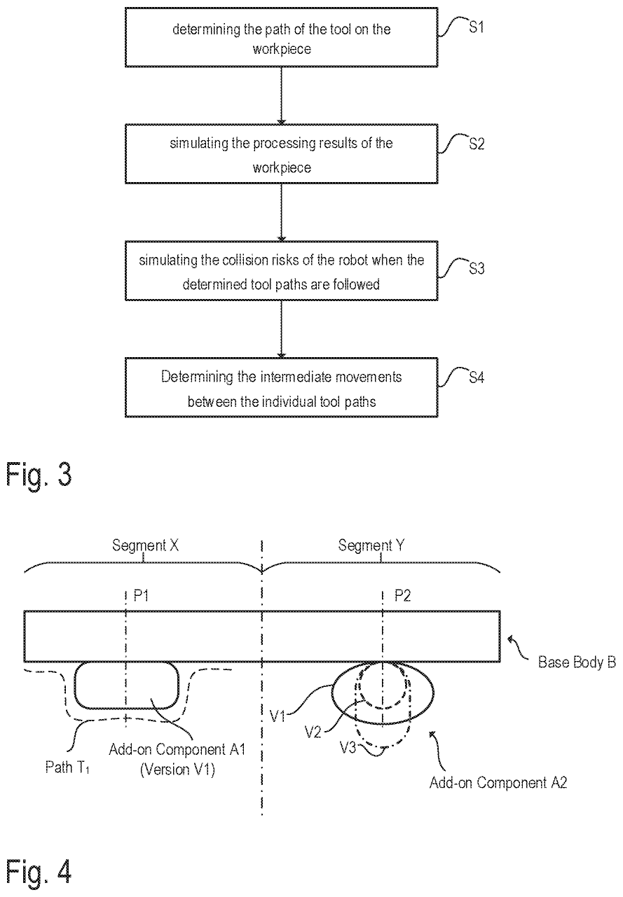

FIG. 3 is a flow chart illustrating the various steps of generating a program for the robot.

FIG. 4 exemplarily illustrates the computer-assisted program generation for various segments of a workpiece.

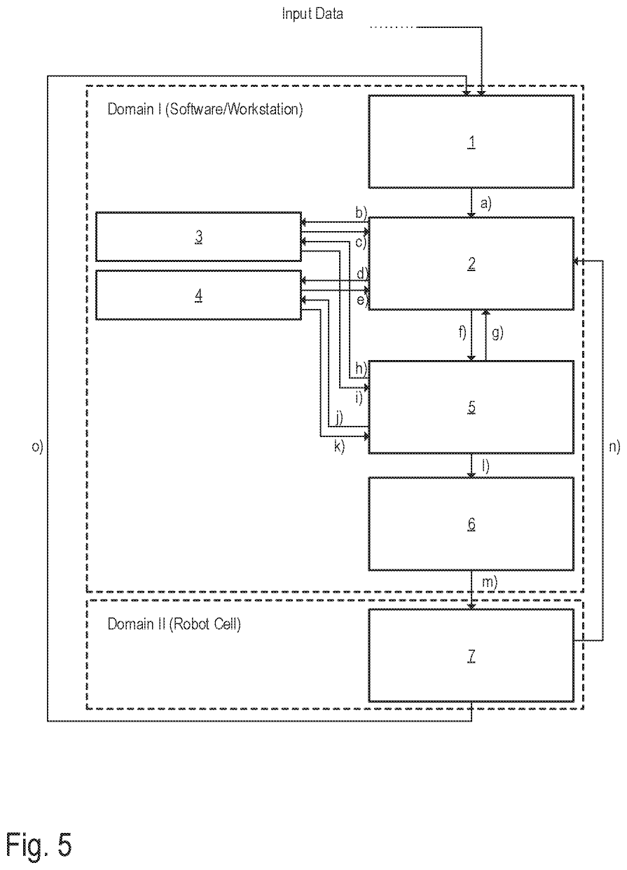

FIG. 5 is a block diagram showing an example structure of offline programming (OLP).

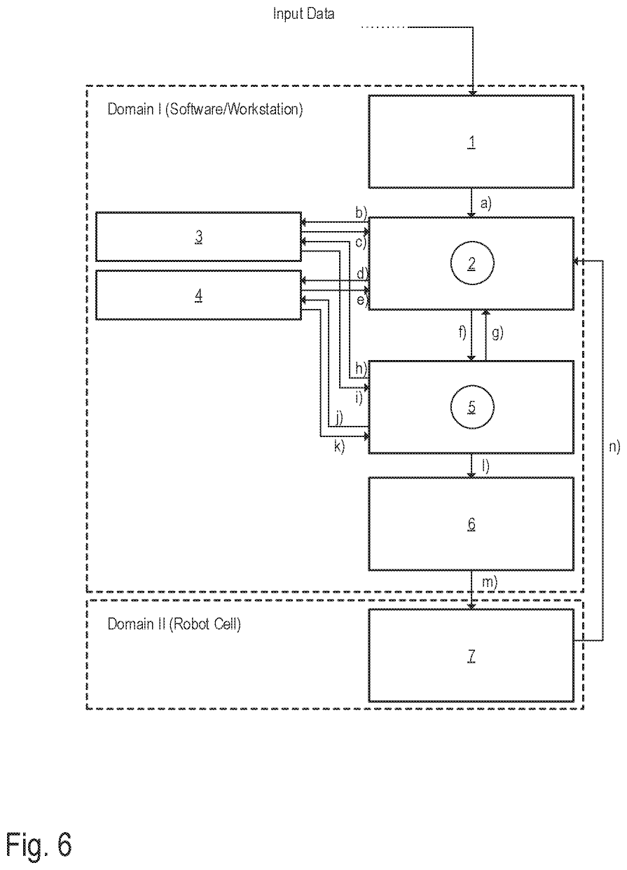

FIG. 6 is a block diagram representing an example of the computer-assisted method described here.

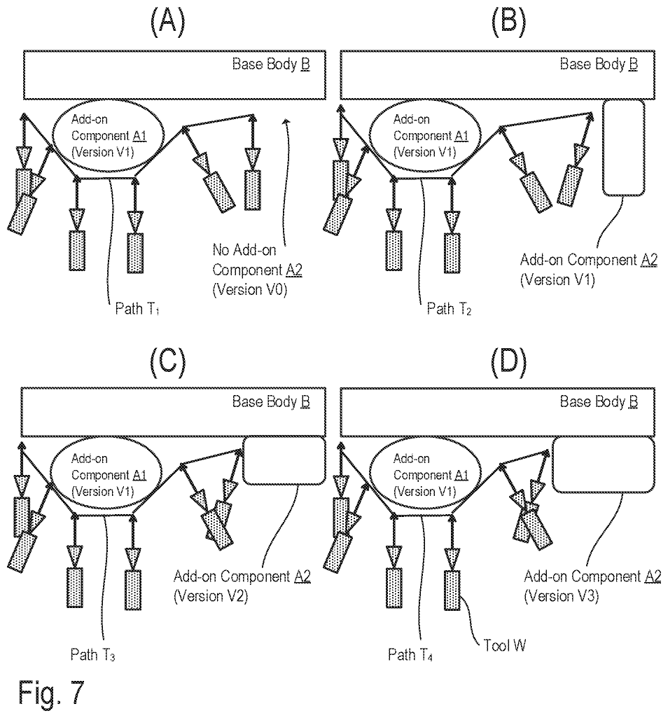

FIG. 7 shows the individual planning of a tool path for different workpiece variants.

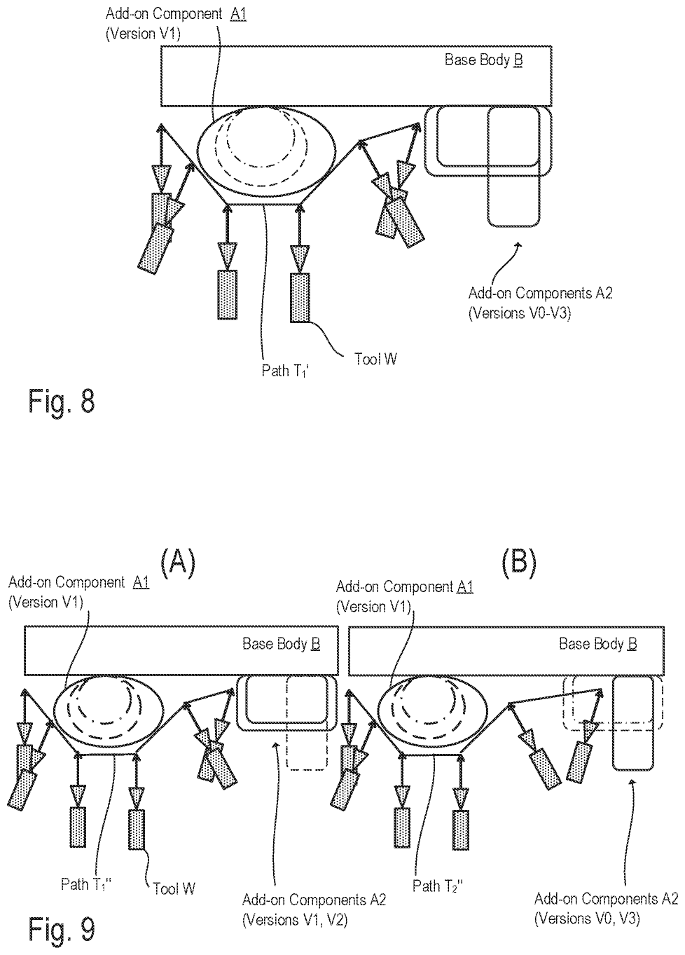

FIG. 8 shows the planning of a tool path based on a virtual superposition of several of the workpiece variants from FIG. 7.

FIG. 9 shows the planning of two tool paths based on two different examples of the virtual superposition of several of the workpiece variants from FIG. 7. In particular, the impact of neighboring add-on components currently not being processed on the paths of the add-on component currently being processed is illustrated and from which two paths for the add-on component would be produced (no decoupling).

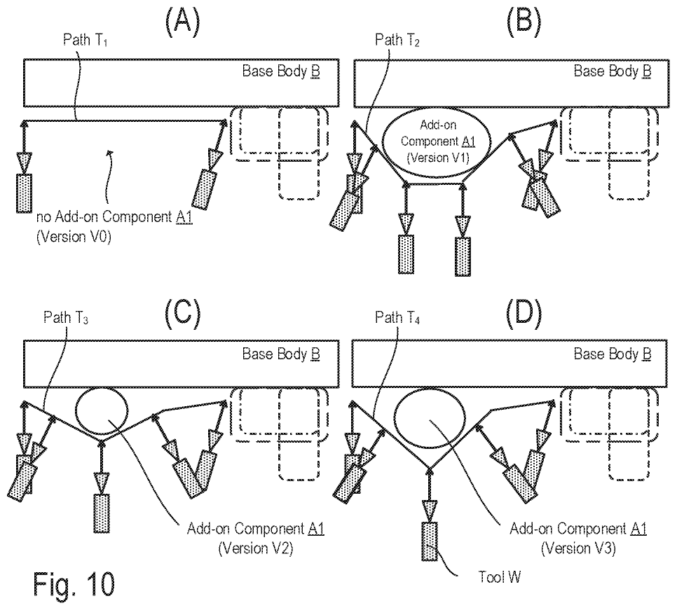

FIG. 10 shows an example of the individual planning of tool paths (or of groups of tool paths) for various concretely implementable workpiece variants. It is also shown how the number of possible combinations can be reduced by employing a maximal model of the virtual workpiece outside of the region currently being dealt with.

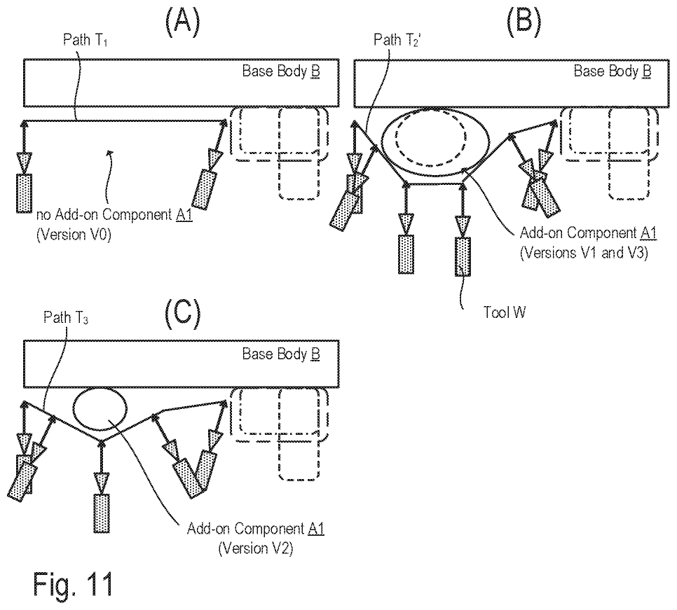

FIG. 11 exemplarily illustrates the number of tool paths (i.e. groups of tool paths) that is reduced by employing the methods described here.

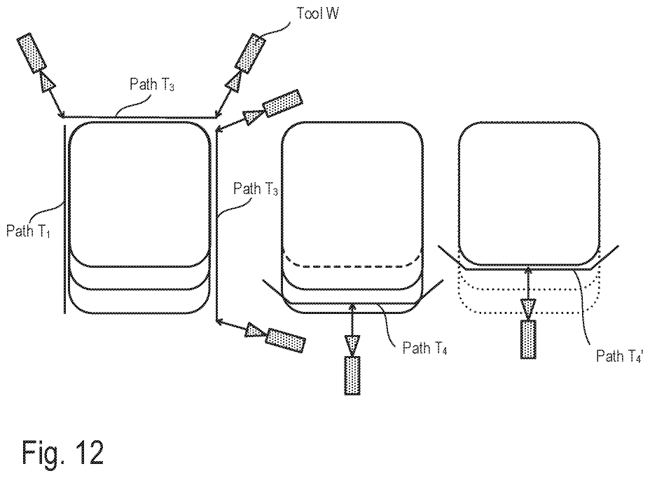

FIG. 12 illustrates how the methods described here are applied to a number of similar workpieces that can be regarded as variants of one base body; the planning generates a minimal number of tool paths for three different variants (reduced to 3+2 paths instead of 3×4 paths) by means of a virtual superposition of numerous workpieces.

### DETAILED DESCRIPTION

The following approaches (A-D) to the programming of robots (including, e.g. automatic, semiautomatic, computer-assisted, manual, etc. path planning) are known: (A) Programming one program per robot for each variant of a workpiece, for example, by means of teach-in or programming by demonstration (PBD) in a robot cell or by means of offline programming (OLP). (B) Dividing the programs per workpiece into sections or sub-regions that are oriented according to the shape/dimensions of the workpiece (virtual “cutting-up” into sections) or according to the areas of deployment of the robots or according to additional actuators and for each of which one program per robot is generated. For example, when a workpiece is placed on a rotatable or movable platform, an individual program is generated for various positions of the workpiece. This approach can be combined with Approach A. (C) The individual programming of the robot paths for individual add-on components and for supporting structures, for example, in the form of individual programs or subprograms that may be subsequently coupled to each other and executed, one after the other. This approach can be combined with the Approaches A and/or B. (D) The fully automatic planning of robot paths on the basis of 3D sensor data that represent the actual shape of the components or on the basis of CAD data (e.g. for the painting of window frames).

Although it may be more efficient to employ teach-in, a different PBD or OLP (Approach A) in combination with the Approaches B and C, manual programming is time consuming and is only economical when a high number of units are produced. When the division is adeptly carried out, breaking down the programs per workpiece into sections to do the programming (Approach B) will also produce sections that are identical for all workpieces and thus only need to be programmed once as they can be reused for the different variants of the workpiece. This reduces the size of the sections that have to be differently programmed for the different variants, thus also reducing the amount of time needed for the processing and programming of each section. This may also lower the number of combinations and the resulting robot program variants. Given N add-on components of which there are V versions, the number of programs would theoretically be reduced from a maximum of (V+l)^{N} to Sx(F+1)^{N/s}, whereby it is assumed that the N components are evenly distributed among the S segments of the workpiece, which is advantageous but not necessarily needed to reduce the effort involved. This means that, using this method, the number of programs needed to cover all combinations of the add-on components will result in part additively from the number of add-on components, and not only exponentially. The programs (program segments) that are determined in this way cannot, however, be regarded as being independent of each other. Add-on components in one segment, for example, may render regions of the neighboring segment inaccessible for the tool the robot is using or have some other impact on the processing of the neighboring segment or they may cause collisions with the robot. In such a case, Approach B fails and the neighboring segments of a workpiece cannot be handled separately. Finally, connecting together the individual program segments can also cause difficulties.

Planning robot paths individually for every add-on (or other component) and region of the base body (support structure/hull) to which the add-on components are attached may increase the granularity and thus shorten the length of the (sub-) programs over that of Approach B (theoretically from (V+1)^{N} to (V+1)×N subprograms). Fewer paths make it easier to optimize the processing. Nevertheless, the individual subprograms cannot actually be considered independently of each other when Approach C is taken either, as neighboring add-ons, components and base bodies will have a significant impact on their reciprocal processing results (cf. impact of masking, electrostatic, etc. during painting). The impact on the accessibility of the planned paths to the add-on components is greater than in Approach B (e.g. due to possible collisions with other add-ons). Depending on the neighboring add-on component (of the respective version), an add-on component of some versions will have to be accessed and processed differently from others (see FIGS. 9-11). Further, the individual paths have to be coupled to each other and, although there will be fewer paths to be programmed, there will be a great number of different combinations of path couplings.

The advantage provided by the completely automatic programming of all paths based on the CAD data or on the basis of 3D sensor data lies in the fact that this makes it possible to generate a single or multiple programs individually for each specific workpiece. In the case of complex workpieces, however, this requires a high degree of processing power and the quality thus achieved is often insufficient. Further, when the programming is carried out completely automatically, this does not allow for possible improvements/optimization of the robot paths on the part of experts nor can the optimizations be reused. Conventional methods of fully automatic robot program generation would produce an extremely high number of different programs, each of which would have to be optimized, delivering very inefficient results.

The examples described here can be applied to enhance or improve the aforementioned Approaches B, C and D and are suitable, for example, for workpieces that have a large number of variants. The robot paths are planned in orientation to each workpiece in an offline programming environment (OLP environment) and the processing results are simulated, as are the movements of the robot in order to verify that there is no danger of collision. Here various levels of automation are possible.

In accordance with the embodiments described here, a system with an OLP programming environment (also known as an OLP software tool) is provided that can be run, for example, on a workstation (e.g. a personal computer). The stored CAD models of numerous workpieces from a group of (similar) workpieces are uploaded into the OLP programming environment. This group of workpieces may include, for example, numerous variants of a workpiece. In FIGS. 1 and 2 examples of numerous variants of a workpiece are illustrated.

The different variants results from variations in the geometry of a workpiece that has locally differing geometric forms in the individual variants which ensue, for example, from differing versions of add-on components. The individual workpieces of a group (see FIG. 2, “Variant 1”, “Variant 2”, “Variant 3”, etc.) each correspond, for example, to a respective different combination of local geometric forms, e.g. add-on components A1, A2, etc. of a base body B. Shown for illustrative purposes is the example of a base body B on which an add-on component (e.g. a tank) can be arranged at four different positions P1, P2, P3 and P4 (to simplify the illustration, only two of the four positions are shown in FIGS. 1 and 2). There may be, e.g., three versions of each add-on, i.e. the versions V1, V2 and V3 (e.g. different construction forms and sizes of the tank), whereas V0 means that the add-on was omitted at the respective position. This means that there are four different possibilities for each of the four positions P1, P2, P3 and P4, namely “no add-on component” (V0), version V1 of the add-on, version V2 of the add-on or version V3 of the add-on. Thus, in total there are 4⁴=256 variants of the workpiece, all or at least several of which can be grouped together into one group of workpieces.

0029 Continuing with the aforementioned example, the CAD models of the base body and of all versions (V1, V2 and V3) of all of the add-on components A1, A2, etc. (at the positions P1, P2, P3 and P4) are uploaded into the OLP programming environment. In this manner, all possible workpiece variants of a group of workpieces can be constructed from the uploaded CAD models. The CAD models of the base body B and of the different add-on versions (versions V1, V2 and V3 of the add-on A1, versions V1, V2 and V3 of the add-on A2 etc.) are superposed (coupled) to form a virtual “maximal model” (see FIG. 1). Thus the CAD model of this maximal model includes the base body B and all possible versions of the add-on components A1, A2, etc. that make up the workpiece variants contained in the group of workpieces. Here it should be noted that, in general, this virtual maximal model cannot exist in reality as numerous workpiece components or add-ons would occupy the same space. The OLP programming environment offers the user or the automatic planning tool (software) the possibility of activating individual versions of add-ons or workpiece components (i.e. including them into the model) or of deactivating them (i.e. removing them from the model):

The aforementioned activation and deactivation of add-ons/workpiece components is not, however, intended to serve the purpose of easily representing or depicting each individual existing workpiece variant. Instead, the activation and deactivation are completely free and independent of any actually existing workpiece components of the group of workpieces in question. The methods provided by the OLP software tool in fact make it possible to represent workpiece variants that do not exist, or cannot even exist, in reality, e.g. mixed forms of actually existing variants, “worse case variants”, variants of maximum dimensions, etc. by means of activating or deactivating them. This can be done both for the entire workpiece, as well as for chosen sections of the workpiece. This means that virtual workpieces can also be represented which, for example, correspond in a region A to the Variant 1 and in regions B, C, etc. to variants other than Variant 1, i.e. maximal models (all versions of the add-ons/components) or intermediate forms such as, for example, “incomplete maximal models” (i.e. models having fewer versions of add-on components that the maximal model of FIG. 1 but having more add-on components than the Variant 1 or a variant with fewer add-on components than Variant 1 (intermediate form between the Variant 1 and the base body (minimal model)).

The model of the virtual workpiece represented with the OLP software tool and based on which robot programs are generated is not necessarily the same in (at) all of the following programming steps/levels. The individual steps/levels in the generation of a robot program that are shown in FIG. 3 are (among others): (S1) determining the path of the tool on the workpiece, (S2) simulating the processing results of the workpiece (that is, for example, the painting results), (S3) simulating the collision risks of the robot (and tool) when the determined tool paths are followed and (S4) determining or planning the sequence (in space and time) of the collision-free robot movements needed to follow the tool paths and the intermediate movements needed between the individual tool paths.

The tool paths are best determined by dividing them into segments, whereby those segments that are not currently being programmed and/or that already have been programmed are at least represented for collision testing (FIG. 3, steps S3 and S4) on, for example, a maximal model having all add-on components A1, A2, etc. in all versions V0, V1, V2, V3, etc. at the same time (even if this is not possible in reality), provided that usable tool paths for all of the segments to be processed can be found. If this is not the case, the add-on versions in the segments not currently being programmed must be divided into subgroups until work paths for each of these subgroups are found that can be used in the segment in question.

The determination of the tool paths can be carried out individually in the region of the add-on components for the respective add-on (or for a superposition of numerous add-ons), wherein the add-ons are never considered in isolation, but instead only in an attached state, i.e. in combination with other add-on components and the base body. In the case, for example, of robots that have additional axes or of workpieces that are manipulated, the planning and simulation of the tool paths (FIG. 3, step S1) can be separated from the planning and simulation of the robot movement sequence (FIG. 3, step S3 and S4) in order to be able to process numerous workpiece variants along a minimum number of tool paths. Given that a single robot can follow along the same tool path in (depending on the kinematics) in what generally amounts to 2×2×2=8 configurations/axis positions (“elbow up”, “elbow down”, etc.), the number of axis positions with which the robot can follow the same path rises significantly when additional axes are employed. The results in a degree of freedom of the robot's processing movements for a determined/planned tool path that makes it possible to avoid collisions with add-on components in different versions by varying the position/movement of the additional axes.

The procedures described here can be advantageous in many applications. Programming every add-on component in its “attached state” (attached to the virtual workpiece model) ensures that only those regions are processed that are actually accessible to the robot. When the tool paths for a given segment of the virtual workpiece model are determined (e.g. for that of the maximal model), for example, all possible add-on components in all of their possible versions can be activated for each of the respective other segments (maximal model). The different versions of the add-on components may occupy overlapping regions in this case, i.e. in reality impossible to realize, but it will be guaranteed that the robot's movements will run no risk of collision. Such a situation is outlined in FIG. 4. In the example illustrated there, a tool path Ti in segment X of the workpiece model is planned for a specific version V1 of the add-on component A1 (cf. as well step S1 of the program generation in accordance with FIG. 3). When simulating the processing and testing the risk of collision (cf. also steps S2 and S3 of the program generation in accordance with FIG. 3) of the planned tool path Ti, the maximal model is considered in all other segments (with the exception of segment X) in order to take into account any existing dependencies. Once a collision-free progression along the tool path Ti has been determined to be possible and the simulated processing quality of the maximal model is found to be acceptable, only a single subprogram version (representing the totality of the tool paths) will have to be defined for this add-on A1, version V1 in all possible combinations in which the add-on component might appear together with the other components. This results in a massive reduction of the required programming effort as the number of possible combinations will be significant reduced. It also massively alleviates the subsequent optimization effort as in this way fewer programs requiring optimization will be generated. If this is not possible (i.e. a collision-free progression along the tool path Ti), the add-on components in segment Y will be gradually further divided (in their different versions) into groups until it becomes possible (for each individual group). This results in a higher number of programs, but nevertheless in a minimal number thereof. Here it should be pointed out that—to the extent possible—all variants of the add-on components should be considered at the same time not only in other segments (e.g. in segment Y), but also those add-ons in the same segment X that are not currently being processed should be taken into consideration in the context of the maximal model. This, however, naturally depends on how the borders of the segments are determined.

In the case illustrated in FIG. 4, only four subprograms (collision-free tool paths that produce sufficient (simulated) processing quality) need to be made available for the versions V0, V1, V2 and V3 because all of the combinations of add-on components in the other segments are included in the maximal model for the collision testing. If it is not possible for the tool path Ti for the maximal model to be followed collision-free, or if the simulated processing quality for the maximal model is insufficient, instead of the maximal model an incomplete maximal model (i.e. numerous combinations of add-on arrangements) can be employed in the segments that are currently not being programmed (e.g. segment Y) which, however, greatly reduces the number of programs and guarantees that the planned paths remain collision-free. In the examples illustrated here there is only one add-on component per segment. If numerous add-ons are present in a segment X that is currently being processed, the maximal model can also be “activated” in segment X for the add-on components not currently being considered.

By activating/deactivating (displaying/hiding) various add-on components, the (virtual) workpiece variants currently being examined can considered at the same time as other versions of the add-on components. This means that tool paths (and the robot movements consequently derived from them) for numerous simultaneously depicted versions of an add-on (all of the versions or a smaller number of the possible add-on versions) can be simultaneously planned (fully automatically, interactively or manually) and/or defined (e.g. projected) and simulated (processing quality, risk of collision), or they can be visualized merely as a support for the programmer and without considering them in the simulation or elsewhere.

A human programmer can have, e.g. two or more versions (V0, V1, V2, etc.) of an add-on component (e.g. in various colors and/or in varying degrees of transparency) depicted (superposition of different versions) and in this way can simultaneously optimize the tool paths (their processing quality, their collision-free progression or their accessibility) for numerous versions in order to obtain well-balanced results from a reduced number of variants that require programming (reduction of combinatorics by amalgamating/superposing numerous workpiece variants).

An automatic programming or optimization can entail an equal or differentiated evaluation of numerous or all versions of the add-on components and thus obtain compromise paths for numerous variants (which reduces the number of subprograms) without having to iterate over all of the CAD models of all of the workpiece variants. In order to test the collision risk, numerous or all (maximal model) versions of an add-on can be immediately superposed and thus taken into consideration, reducing the needed programming time while producing more reliable results.

In accordance with the examples described here, in which the segments (cf. FIG. 4, segments X, Y, Approach B) or add-on components (Approach C) other than those currently being processed are not considered in the specific manifestation of the variants that are currently to be processed but instead, e.g. as maximal model, the neighboring segments or add-ons can, in fact, be taken into consideration independently of each other. This significantly reduces the number of possible combinations and the number of programs (derived from the tool paths). In very general terms this means that, with N given add-on components that have V versions, the number of programs is not only theoretically reduced (if it happens that all combinations turn out to be accessible and collision-free), but also in reality, from a maximum of (V+1)^{N} to Sx(V+1)^{N/S} (wherein here an even distribution of the N components over the S segments is assumed, which is advantageous, but not necessarily needed to reduce the computational effort).

The planning (determination) and simulation of the tool path can be separated from the simulation (for the collision testing) of the robot movements needed to follow the tool path. This may be of particular advantage for robots that have additional axes or for workpieces that are positioned by means of manipulators. The same tool path can be used repeatedly for the different versions of the add-on components not currently being considered, even if they are not accessible to the robot with the same robot movements in all of the other combinations of add-on components; only the position of the additional axes has to be changed for the other “displayed” add-ons in order to avoid collisions—this reduces the number of tool paths and combinations that need to be optimized. This means that, at a later point in time when the position of the robot relative to the workpiece has been changed by selecting a different position of the additional axis, the progression of the tool path will only deviate insignificantly despite the fact that the robot axes move completely differently (the robot stands, e.g. to the side and in front of or to the side and behind the add-on component), making it possible to avoid collisions with different add-on components by assuming different positions of the additional axis. The time-consuming optimization of the tool path (often by means of trials in the robot cell or, in the case of painting, by measuring the achieved layer thickness) will thus be the same for different add-on components and the results of the optimization can be used for all of the programs, i.e. for all variants of the add-on components that have the same tool path—only the robot movement itself differs. The latter, however, can be automatically planned collision-free without undertaking (e.g. painting) trials.

In general, the procedures described here make it possible (thanks to the reduced number of add-on combinations) to easily call up and automatically couple the subprograms (for different versions of the add-on components) when planning the movements automatically using an OLP software tool. In praxis this means that the tool paths and programs can be more easily optimized as their number will be reduced. The examples described here are also applicable for the fully automatic planning of the tool paths. This significantly reduces the computational effort needed to generate the programs and, in particular, also reduces the effort needed at a later point in time to optimize the tool paths as the number of programs and tool paths requiring optimization will be significantly lower. Depending on the number of workpiece variants, the procedures described here make it possible to plan the paths, generate the programs and, when needed, optimize both within a realistic time span.

As opposed to “classic” OLP programming, when generating the program in this manner the steps of determining the tool paths (cf. FIG. 3, step S1) and the following step of (automatically) planning the movement (in space and time) of the robot (including the collision testing) are not carried out on the same (CAD) model. The production costs entailed in the programming and optimization of robot programs arise for the most part from the determination and maintenance (optimization) of programs and of the tool paths they contain. In particular in the case of complex processes that are not easily simulated such as, e.g. painting, defining and optimizing the paths requires a great deal of time—more than the amount of time needed to optimize the robot movements needed to follow the paths (path and configuration as well as the position of the additional axes). In this case the aforementioned solution entailing determining the tool paths (for a “virtual” variant of the workpiece) from the subsequent, e.g. automatic movement planning (with other variants of the workpiece, e.g. the maximal model) be of particular advantage over defining the movements of the robot as done in classical OLP because the second part—planning the movement—is easy to simulate and plan, whereas the tool path itself—despite the simulation of the spray paint application (in the case of a painting process) will still have to be analyzed and optimized using a real-life application of the spray paint (due to inadequacies of the processing simulation that arise in complex processes and workpiece geometries).

Separating, as described above, the task of defining the tool paths from that of planning (in time and space) the robot's movements and, in particular, combining this with the approach described above involving simultaneously taking into consideration numerous versions of the add-on components (in the same and/or different segments) that are not being processed from the tool path to be optimized, makes it possible to use one tool path in numerous programs (often with differing axel-positioning of the robot) and for a great number of variants. In this manner, following the first workpiece variant for which this tool path is used, not only will one program or robot movement be optimized for a variant, but rather a tool path from which other variants can also be processed. Furthermore, the actual movements needed by the robot (robot program) to follow this tool path can be calculated, e.g. automatically for all of the variants and numerous versions of the add-on components can be (manually or automatically) taken into consideration, allowing for many variants of the workpiece to be optimized at once.

In spatially constricted robot cells, finding the right movements is more difficult, i.e. the automatic planning of collision-free movement requires more computational effort. In such cases, using superposed add-ons does not only make finding the right robot movements a less complex task, using them for numerous versions of the add-ons also reduces the number of times that the planning tool has to be run.

In the following, an example of conventional OLP programming will be described in greater detail based on the block diagram from FIG. 5. The domain labeled I comprises (among others) Modules 1-6, which are implemented as software on a workstation. These Modules 1-6 are provided by a software tool (programming tool) that automatically, or interactively with a process operator (e.g. when painting the surface of a workpiece), plans the movement of the robot (in time and space) and generates robot programs (movement commands, parameters, signals, . . . ) that can be run on a robot controller. The domain labeled II represents the robot cell including a robot controller and at least one robot on which a tool is mounted (at the TCP of the robot). The robot(s) process(es) one or more workpieces. Alternatively, the robot can hold the workpiece and move it relative to the tool, which in this case is not mounted on the robot, but rather on the cell, on an additional actuator or on an additional robot. The robot with the tool is represented in FIG. 5 by Module 7.

The input data supplied to Module 1 for the most part represent the CAD data of the base body B (cf. FIG. 1) of the workpiece variants and of all add-on components A1, A2, etc. (in all of their versions V1, V2, etc.), as well as further parameters that represent the desired results of the surface processing (the desired state in which the workpiece variant is to be after processing) and CAD data regarding the robot cell. Module 1 represents an interface (e.g. a human-machine interface, a user interface, a machine-machine interface, etc.) for inputting the description of a single workpiece variant or the description of the workpiece base body and the add-on components that can be added to the workpiece variant by combining the base body with a chosen combination of add-ons. The workpiece is then placed in a virtual robot cell.

Module 2 provides functions for manually, semi-automatically or automatically defining/determining tool paths or groups of tool paths for a workpiece (or a part thereof) that corresponds to a real, existing variant of the workpiece. A graphic interface may also be provided to display the simulation results (Modules 3 and 4). Module 3 provides functions for verifying (by means of simulation) the collision-free progression of tool paths (from Module 2) and of the robot movements (of the entire robot/from Module 5) that are needed to follow the tool paths. It is also possible to visualize the simulation so that, in addition to the automatic identification of possible collisions, the collision can be displayed to the user as well. The simulation can be carried out in two steps, wherein first only the movement of the tool along the determined path is simulated and the risk of collision is tested. In the next step, the required robot movement and their chronological sequence can be calculated and simulation can be used to verify that the planned robot movements will be collision-free.

Module 4 provides functions for simulating the process, in particular for simulating the processing results (e.g. the thickness of the layer of paint in a painting process) that will be produced when the tool (e.g. a sprayer) is moved along the predetermined tool path as planned. In other words, the module contains a process simulator that uses a process model for the simulation and that can simulate with, the aid of this process module, the results of processing a workpiece along (one or more) planned/optimized tool paths. The process model contains the information needed for the simulation. In the case of a painting process, for example, this information may comprise the spray pattern produced by the sprayer, the minimal and maximal distance of the sprayer to the surface, the minimal and maximal desired layer thickness, electrostatics, etc.

Module 5 provides functions for the (temporal and spatial) planning of the robot's movements and, if given, of any additional axes present, both for the movement along the tool path, as well as for movement between the individual tool paths (that is, from the end of one path to the beginning of the next one). This planning can be carried out manually, semi-automatically or completely automatically.

Module 6 provides functions for exporting the robot programs for a workpiece variant or for a group of variants. At best this is done using program names or other clear means of identification (e.g. product numbers) that allow the programs to be retrieved from a manufacturing execution system (MES) or similar. The exported programs are saved, either to be run at a later point in time or for later reuse. Module 7 represents the robot and the robot controller that are intended to execute the previously generated robot program, wherein the actual performance and the actual processing results that are achieved can be evaluated both after carrying out the processing (e.g. when painting, by measuring the thickness of the paint layer at selected points of application and by checking for paint runs or places at which too little paint has been applied using optic sensors), as well as during processing (e.g. when sealing joints/soldering, by means of a sensor arranged behind the tool).

The data flow between the individual modules is labeled with the letters a) to o) in FIG. 5. Letter a) represents the description of the object to be processed (of a specific workpiece variant) and of the robot cell for which the programming is to be carried out. Letter b) represents the determined tool paths with parameters such as, e.g. speed of the TCP, processing parameters such as grinding distances at transitions, airbrushing settings, sprayer on/off, etc. and the description of the object to be processed (that of a specific workpiece variant) and of the robot cell (or only of the workpiece and tool) for which the collision testing should be carried out. Letter c) represents the results of the collision testing for the tool paths that are subject to the collision testing. Possible results of the latter include “collision” and “no collision” and, when a collision risk is detected, information about the time and place of the collision (i.e. which path the collision takes place on, when and at which point on the path the collision takes place and which objects collide).

Letter d) represents the determined tool paths with parameters (e.g. speed of the TCP, processing parameters such as grinding distances at transitions, airbrushing settings, sprayer on/off, etc.) and the description of the object to be processed (that of a specific workpiece variant) and of the robot cell (or only of the workpiece and tool) for which the processing simulation (e.g. simulation of the painting process) should be carried out. The impact of the individual tool paths on the processing results can also be taken into consideration. Letter e) represents the simulated processing results, e.g. the impact of the tool path(s) that are simulated (letter d) on the processing results. These processing results may include, for example, the thickness of a layer of paint.

Letter f) represents the tool paths for a specific workpiece variant that have been planned in Module 2 and verified by simulation in Modules 3 and 4. Letter g) represents the results of the simulation/verification of the robot's movements from Module 5 that are carried out if a problem is identified that requires Module 2 to adapt the tool paths. For example, a planned tool path may lead to a collision when followed by the robot (e.g. another robot collides with the robot that is following the tool path in question, or the robot that follows the tool path in question runs the—unavoidable—risk of colliding with its environment or of coming too close to a singularity). The letters h), i), j) and k) basically correspond to the letters b), c), d) and e), wherein, during the second simulation in Modules 3 and 4, not only the movement of the tool along the planned tool path and the thus achieved processing results are simulated but instead the entire movement of the robot that moves along the planned paths, as the case may be also together with other robots and machines found in the robot cell and, where needed, including deviations from the planned path that are caused by specifics pertaining to the robot (grinding of transitions, deviations in the speed, mass, dynamics, etc.).

Letter 1) represents the planned tool paths, verified by simulation, (the movement simulation in Module 3 and the process simulation in Module 4), including the speed of the tool. Letter m) represents the transmission of an executable robot program (movement commands, parameters, signals, etc.) to the robot controller (Module 7). Letter n) represents a message that is generated if a problem arises while the program is being run in real life (e.g. if the processing results are unsatisfactory). Letter o) represents the return to the beginning of the program generation for the subsequent workpiece variant.

While FIG. 5 serves to illustrate the distribution of the individual steps/levels in the program generation among various modules, it also depicts in greater detail the procedure illustrated in FIG. 3. In this respect it should also be noted that the Modules 2 and 5 may also be combined into one module. In this case then the planning and verification of the tool paths on their own and of the corresponding robot movements are not carried out separately. Instead the robot movements are immediately determined for the individual paths and are verified by simulation. It is also worth mentioning that, in “classic” program generation as illustrated in FIG. 5, only one specific workpiece variant is considered at a time (base body B with a specific combination of add-on versions A1, A2, etc.) and the entire procedure has to be repeated for every single workpiece variant (cf. FIG. 5, letter o). Although with “classic” program generation (as shown in FIG. 5) it is also possible to test whether a program planned for an individual variant (or a path planned for an individual variant) can also be used for a different variant, since the interplay between the processing and the movement is not taken into account when doing so, generally this produces only a small number of usable (or usable without adaptation) programs or tool paths.

An example of improved OLP programming in accordance with the approaches described here will now be explained using the block diagram of FIG. 6. The illustrated Modules 2-7 are essentially the same as those in the example of FIG. 5. The main difference is that not the same CAD models of the same workpieces are used when planning the individual tool paths and simulating the movement and the processing. With regard to the Domains I and II (software/workstation and robot cell), reference is made to the description of FIG. 5. In the following, the differences between the method illustrated in FIG. 5 and that of FIG. 6 will be the main point of discussion.

First, a virtual workpiece is generated by combining (e.g. CAD) models of numerous variants of a workpiece. Here the input data comprises, e.g. CAD data that define the workpiece variants and the desired finished state after processing by the robot. Module 1 is configured to retrieve the workpiece descriptions (CAD models) as separate components (e.g. the model of the base body and of all add-ons) and to couple all of the components in all of the workpiece variants in order to represent the virtual maximal model that was explained above. This means that—as opposed to the example in accordance with FIG. 5—not specific workpiece variants are generated from a specific combination of add-on components with the base body, but instead non-real, virtual workpieces are generated by superposing numerous versions of the add-ons (or different versions of the base body). The model is positioned in the virtual robot cell. Regardless of whether the model is complete (covering all variants—a maximal model) or incomplete (covering only some of the possible variants), numerous variants of the workpiece to be processed are superposed in every one of them and coupled to form a virtual workpiece. Individual versions of specific add-on components can be selectively activated (displayed and added to the virtual workpiece) or deactivated (removed from the virtual workpiece and hidden). Here again attention should be called to the fact that, in the virtual workpiece, numerous add-on components or versions thereof may occupy the same space, which in reality is not possible.

Module 2 represents a module for the manual, interactive or automatic defining/planning of tool paths or groups of tool paths for various combinations of add-on components that do not necessarily correspond to existing, virtual workpiece variants. For every tool path or group of tool paths (and thus for every region of a workpiece that is to be covered by the tool paths) it is possible to define which add-on components should be “activated”, i.e. considered in the simulations (for the collision test and the processing simulation), and which should not. This, in other words, is the point at which the specific variants or groups of variants to which the planned tool paths are assigned first come into play. A tool path or a group of tool paths can be optimized, simulated and verified for a local form of different variants (e.g. different versions of an add-on) and can then be immediately (locally) assigned to numerous workpiece variants, whereas for other add-on components (in the same or in different segments) it is best not to use the CAD description of a variant but instead the superposition of all variants of the add-on (i.e. maximal form, worst-case form), or of a smaller group of all of the variants if no solution can be found for all of them. This ensures that none of the other add-on components run the risk of collision or of being negatively impacted (hidden) and significantly reduces the number of combinations for which tool paths in a (local) region of the workpiece (i.e. a segment or part of a segment or add-on component with the environment of the workpiece) need to be defined/planned. A graphic interface may also be provided to display the results of the simulations.

With regard to Modules 3 and 4, reference is made to the description of FIG. 5. The simulation of the tool paths can either be carried out in two stages (first only the movement of the tool and then all of the robot's movements including their chronological sequence) or in one stage (only the robot movements needed for the planned paths). At least in some segments or regions of the workpiece, not a specific variant, but rather a superposition of numerous (or of all) variants (i.e. a virtual workpiece) is considered. The same applies to the simulation of the processing results. Here it should once again be pointed out that the number of geometric forms (i.e. add-on components) superposed in the virtual workpiece will differ (and be generally smaller, in the best case only one) in a region for which the planning (and verification) of the tool paths is currently being carried out from that of the other regions (of the same segment or of other segments) of the virtual workpiece (for which no paths are currently being planned but which are nevertheless considered during verification/simulation. In the best case, a superposition of all geometric forms of the workpiece will be considered in the remaining regions (i.e. the maximal model).

In the example of FIG. 6, the module 5 serves to define (i.e. plan) collision-free robot movements (including their chronological sequence) that follow the tool paths previously planned with the aid of Module 2. It is important to note that the virtual workpiece used in Module 2 for the planning of the tool paths is not necessarily the same as the virtual workpiece used for the (e.g. automated) planning of the robot movement. In other words, the tool paths are planned based on a (virtual and not necessarily implementable) combination of base body and add-on components, whereas the robot movements needed to follow this tool path are planned based on a different (virtual and not necessarily implementable) combination of base body and add-on components. In the process, the following situations may arise: (i) the virtual workpiece may comprise more versions of the add-on components for the planning of the robot paths than for the planning of the tool paths in order to compensate the security against defects in the assembly and in order to keep the number of programs small (with the same number of tool paths); (ii) the virtual workpiece can comprise fewer versions of the add-on components for the planning of the robot paths than for the planning of the tool paths if the run time is an optimization criterion and the shortest movement possible is always to be found (even when the tool paths for different workpiece variants should be the same in order to reduce the time needed for the later optimization of the processing results); (iii) the same virtual workpiece is used for the planning of the robot movements as the one used for the planning of the tool paths, which reduces the time needed to optimize the robot movements. As previously explained, different virtual workpieces can be generated very easily using the software tool by activating or deactivating specific versions of add-on components. This means that every virtual workpiece can be derived from the (complete) maximal model by deactivating individual add-on components until the desired combination of add-on components (which itself may comprise a superposition of various, in reality implementable workpiece variants) remains.

If no robot movement can be found for a tool path that can also be used for all selected versions of the add-on components with identical and acceptable robot movements, in all three cases (i, ii iii) there are three possible courses of action: (a) First, in order to plan the robot movement the variants are further broken down and for those versions of the add-on components that have caused problems (e.g. collisions, no circumventing movement found, positions not within reach of the robot, etc.) they are divided into subgroups and for each subgroup different robot movements are planned. (b) Second, the tool path is adapted for all variants based on the data gained regarding the problem with planning the robot movement (e.g. the position or orientation of the tool is changed, the TCP or flange position is altered to “push the robot away” from collisions or the TCP or flange position is altered to “pull the robot closer” when it is not within reach). (c) Third, the tool paths are duplicated and are only adapted for those variants (versions of add-on components) for which no robot movement for the tool path could be planned and for these a new tool path is planned.

As opposed to Module 2, however, when planning the robot movement (including its chronological sequence), it is not defined for each tool path (or group of tool paths) which add-on components should be activated (i.e. considered in the (collision and processing results) simulations) and which should not. Instead, here a complete, collision-free movement sequence (i.e. the basis for a robot program that can later be exported, see Module 6) is defined/planned for each segment and robot and generally for numerous variants of the workpiece as well, whereby only tool paths are used that correspond to the respective variant.

In contrast to Module 2, planning is no longer carried out path by path in region after region (e.g. add-on by add-on), (whereas the remaining regions/add-ons can be selected independently, e.g. as long as possible the maximal model), instead (only) those variants are considered for the entire current segment that are actually intended to be produced (in the short or long-term future) or processed, whereas the maximally possible model in accordance with the results from Modules 2, 3 and 4 (the one with the most possible superposed variants) is maintained for other segments in order to compensate for external errors as well. For this purpose, the add-on components (in general these are regions with local geometric characteristics) in the segment under consideration are identified from a list of variants and the corresponding model (i.e. the virtual workpiece) is constructed. Then the tool paths planned for the combination of add-ons in Module 2 and simulated in the Modules 3 and 4 are selected and all of the remaining add-on components (from the same and other segments) are selected in accordance with the intersecting set of add-on components that were planned and tested for the selected tool paths in Modules 2, 3 and 4 and that at least contain the add-on versions defined in the variant (in simple cases, for the other segments this will be the maximal model, and for the current segment it will be the versions of the add-on components that correspond to the variant plus, in certain cases, further versions of these add-ons). The complete movement sequence is planned for this combination of paths and add-ons and the selected robot, whereas the other robots, with the segments, paths and add-ons assigned to them, can also be included in the movement planning in order to exclude any possibility of collision.

Each of the paths used was individually tested in Modules 2, 3 and 4 with regard to defined/known variants of add-on components and (thereby) to exclude defined/known variants of workpieces, whereby, from the intersecting set of add-on versions or variants assigned to the paths currently being used (in Module 5), all of the variants are identified that are covered by the resulting robot movements (movement sequence, corresponding later in Module 6 to the robot program). The entire intersecting set of component variants is assigned to these robot movements or robot programs. As an alternative, or if it is still not possible to obtain desired results by modifying the tool paths (in Module 2) or the robot movements (in Module 5) that correspond to the specifications of all used versions of the add-ons, the group of versions covered is broken down by dividing the movement planning into two or more cases (groups of product variants) in which the critical add-on components are put into subgroups of their covered versions, and (in Module 2) tool paths (as well as signals, processing parameters, etc.) and/or (in Module 5) robot movements are (separately) planned and improved for every new subgroup of add-on versions. Alternatively, the planning of the robot movement in the respective segment can also be carried out only for a current variant and in the case of a “frozen solution” it can be tested for and extended to other variants by activating the other versions of the add-on components.

In all of the cases described above, regions of the component that are not processed from the tool paths under consideration (e.g. when processing in segments or when processing in accordance with the shift/advancement or rotation of the component or skid, etc.) are not represented by the specific workpiece variant intended to be implemented, but by superposing all versions of the add-on components (maximal form, worst-case form), that is, by superposing all versions of the add-on components that were identified in the movement planning of Module 2 and the simulations of Modules 3 and 4 as being “ok” for the tool paths intended to be used. This will ensure that all of these add-on components avoid collisions and any other negative impact (hiding) and significantly reduces the number of combinations for which tool paths for the region in question have to be defined. With regard to Modules 6 and 7, reference is made to the description of FIG. 5.

The flow of data between the modules is represented with the letters a) to n), as in FIG. 5. Letter a) represents the description of all workpiece variants of a group (no specific workpiece variant) and of the robot cell, for example, the CAD model of the base body and of all versions of all the add-ons that can be superposed/coupled into the aforementioned (virtual) maximal model. Letter b) represents the tool paths (or tool paths and their parameters) planned for a subgroup of all variants (of the maximal model), the description of the virtual object to be processed that includes the subgroup of all possible variants for which the tool paths were defined, as well as (optionally) a description of the robot cell for which the collision test is later to be carried out. Letter c) represents the results of the collision testing of the paths supplied to Module 3. Possible responses are “collision”, “no collision” and, in the case of a collision, specific data regarding the place and time of the collision (along which path does the collision occur, when does it occur, at which position and with which object, etc.).

Letter d) represents the defined tool paths with parameters and the description (CAD model) of the subgroup of all possible workpiece variants currently being considered and of the robot cell (or only of the workpiece and tool) for which the processing simulation (e.g. the simulation of a painting process) is to be carried out. In the process, the impact of the separate tool paths on the processing results can be considered. Letter e) represents the simulated processing results or the impact of the simulated tool path(s) on the processing result (letter d). The processing results may comprise, for example, the thickness of a layer of paint. The processing results are simulated for every version of an add-on component or for every variant and are displayed or relayed individually or in summary (e.g. in painting processes, as a percentage of the surfaces that have varying layer thicknesses, of those that are simply “ok” or “not ok” or detailed processing results for every part of the surface of the respective variant).

Letter f) represents the tool paths that were planned in Module 2 and verified by simulation in Modules 3 and 4 for all workpiece variants or a subgroup thereof. As previously mentioned, Module 5 is configured to plan the robot movements needed to follow the tool paths and to verify them by means of simulation. Letter g) represents the results of the simulation/verification of the robot movements from Module 5 that is carried out if a problem is identified that requires the adaptation of the tool paths in Module 2. For example, a planned tool path may cause a collision when followed by the robot (e.g. another robot collides with the robot that is following the tool path being considered). The letters h), i), j) and k) basically correspond to the letters b), c), d) and e), whereas not only the movement of the tool along the planned tool path and the thus obtained processing results are simulated in the second simulation in Modules 3 and 4, but rather the entire movement of the robot as it moves the tool along the planned path, as the case may be together with other robots or machines in the robot cell and, when needed, including deviations of the movements from the planned tool path due to the robot's behavior (its dynamics, when grinding transitions, etc.).

Letter l) represents the planned tool paths (including the speed of the tool), verified by simulation (movement simulation in Module 3 and processing simulation in Module 4). Letter m) represents the transmission of an executable robot program (movement commands, parameters, signals, etc.) to the robot controller (Module 7). Letter n) represents an error message for the event in which a problem arises when a robot program is actually implemented (e.g. the processing results are unsatisfactory).

In the following figures, representative examples will be used to once again highlight how the approaches to robot programming described here can be applied to significantly reduce the number of robot paths that need to be planned and for which the processing results have to be optimized. FIG. 7 shows the planning of a single tool path for various, genuinely implementable workpiece variants as is done in classic OLP. As a simple example, a base body B with two add-ons A1 and A2 is considered, wherein the version V1 of the add-on component A1 is used and, one after the other, the versions V0 (no add-on), V1, V2 and V3 of the add-on component A2. Thus tool paths must be planned for four different variants, namely A1 (V1)+A2 (V0), A1 (V1)+A2 (V1), A1 (V1)+A2 (V2) and A1 (V1)+A2 (V3). These four workpiece variants are depicted in the diagrams A, B, C and D of FIG. 7. The tool W in the present example is a sprayer used to paint the surface of the workpiece.

The other add-on components also have an impact on the position of the tool paths in the region of the add-on component A1 (in the present case, the add-on component A2). When a workpiece is processed, V different tool paths (in the present case, T₁, T₂, T₃ and T₄) may be needed to process a region of the workpiece (e.g. a region around a specific version V1 of an add-on component A1), depending on the “neighboring” add-on (which may comprise V versions). Given N neighboring add-on components with V versions of each there will be V^{N} different tool paths. Even when there only a few add-ons with only a few versions of each, this results in a relatively high number of differing tool paths. V=4 and N=10 already adds up to over one million possible combinations. The approach described here can help to massively reduce this number. By following the example from FIG. 7, the number of differing tool paths (or groups of tool paths) can, in the best case, be reduced to one. This situation is illustrated in FIG. 8.

In accordance with FIG. 8, a single tool path TV (or a group of tool paths) is planned for the processing of the workpiece in the region of the add-on component A1 (version V1), whereas a virtual workpiece is used for the planning of the tool path and for the collision testing (FIG. 6, Module 3) in which all possible versions of the add-on component A2 are superposed. In the example illustrated here, with the exception of the specific add-on component A1, the maximal model is used. A simulation can also be carried out separately (in parallel) for each variant and the results can be displayed or assessed (separately for each variant or as a sum of all variants).

If the verification of the tool path Ti fails (e.g. the simulation predicts a collision or the simulated processing results are unsatisfactory), the planning of the tool path can be divided into two cases, as illustrated in FIG. 9. In diagram A of FIG. 9 a tool path T₁′ is planned for a virtual workpiece in which the versions V1 and V2 of the add-on component A1 are superposed and in diagram B of FIG. 9 a tool path T₂″ is planned for a virtual workpiece in which the versions V0 and V3 of the add-on component A2 are superposed. Even in those cases in which it is not possible to reduce the number of tool paths (or groups of tool paths) to the absolute minimum (as in the example of FIG. 8), a significant reduction (in the example of FIG. 9 a halving) of the number of tool paths can nevertheless often be achieved.

FIG. 10 then shows the individual planning of tool paths (or of groups of tool paths) for workpiece variants (in one region) that are actually implementable (various local geometric forms of the workpiece in the left-hand region of the illustrations), as it would be carried out in classic OLP. However, a superposition of all geometric forms (versions of the add-on component) is considered for the add-on in the right-hand region of the illustrations. As a simple example, a base body B with two add-on components A1 and A2 are considered, whereas, in the right-hand region, all versions of the add-on component A2 are taken into consideration, as opposed to which, in the left-hand version, four different workpiece variants are considered (using all the while the maximal model in the region around add-on component A2) by varying the version of the add-on component A1 (and keeping add-on component A2 the same). No add-on is intended in diagram A of FIG. 10 for the base body B (i.e. version V0) and the tool path T₁ can run parallel to the surface of the base body (and up to the add-on component A2). As shown in diagram B of FIG. 10, the (large) version V1 of the add-on component A1 is used and the tool path T2 can lead around the add-on component A1. In diagram C of FIG. 10 the (small) version V2 of the add-on component A1 is used and the tool path T₃ also leads around the add-on component A1, albeit at a lesser distance to the base body B than in diagram A. The tool path T₄ for the (middle-sized) version V3 of the add-on component A1 is planned in a similar manner. Thus, when there are Vgiven versions of an add-on component, V tool paths are planned (provided the neighboring add-on components remain the same). By following the example of FIG. 10, the number of different tool paths (or groups of tool paths) can, in the best case, be reduced to one and, in the actual case illustrated in FIG. 11, reduced by one. This situation is illustrated in FIG. 11. Here it is important to point out that, if every version were to be taken separately into consideration for the right-hand add-on component A2 as well, instead of four tool paths, sixteen (4 times 4) would be planned.

By selectively activating/deactivating single or numerous versions of an add-on component (or of numerous add-on components), the approach to program generation that is described here helps to reduce the set of paths that has to be planned, verified and optimized for each add-on component of which differing versions are used. As illustrated in FIG. 11, a single tool path T₂'is used for two versions V1 and V3 (see FIG. 11, diagram B) of the add-on component A1 (after the paths have been planned, the processing results have been simulated, the collision-free movement of the tool has been simulated and the movement of the robot has been planned/validated). In the example illustrated here, a separate path T₁ or T₃ is only planned for the version V0 (no add-on component A1) and for the small version V2 of the add-on component A1. These paths T₁ and T₃ are only planned (separately) if, e.g. the processing simulation/verification reveals that the path T₂′ does not produce satisfactory processing results for the versions V0 and V2. The number of paths is reduced from four to three.

As the example of FIG. 12 highlights, the approach to program generation described here can be applied not only to workpiece variants resulting from different combinations of add-on components on an (identical) base body, but also to a group of similar workpieces, for example, similar product variants of a product family. In this case as well, numerous (or all of the) product variants of the family under consideration can be superposed and coupled into a virtual workpiece. In the example illustrated in FIG. 12, the superposition of the three variants represents the maximal model. The tool paths T₁, T₂ and T₃ for all variants of the workpiece of the product group are simultaneously determined/planned and simulated (processing, collision testing), wherein all workpiece variants (maximal model) are activated for the planning. If certain regions of the virtual workpiece remain that cannot be processed with sufficient quality (which will be revealed during simulation of the processing results), a minimal set of tool paths will be defined (in the ideal case) for the subgroups of all of the workpiece variants and will be assigned to the respective workpiece variants of the subgroup under consideration.

In the following, a few important aspects of the invention will be summarized. Here it should be noted that this is not an exhaustive listing of essential features but only an exemplary recap. One embodiment relates to a method for the computer-aided programming of robots for the processing of workpieces. The method comprises generating a first virtual workpiece by superposing (e.g. CAD) models of numerous variants of a workpiece using a software tool run on a workstation, as well as carrying out a path planning to determine tool paths for at least one first region of the workpiece and including verifying the determined tool paths based on the first virtual workpiece. The method further comprises generating a second virtual workpiece by superposing models of numerous variants of the workpiece using the software tool, wherein the first virtual workpiece does not comprise the same number of supposed workpiece variants as the second virtual workpiece and, finally, carrying out a path planning to determine tool paths for at least one second region of the workpiece, including verifying the determined tool paths based on the second virtual workpiece (cf. FIG. 6). The planning/verification of the paths are thus carried out region by region for different regions of the workpiece based on different virtual workpieces. Outside of the region currently under consideration, e.g. the maximal model, which represents a superposition of all possible variants, is used or, if no collision-free movement can be found or planned for the maximal model, outside of the region under consideration different versions that are “as close as possible to the maximal model” are tested. This means that the planning is further divided into various subgroups (virtual, incomplete models) until suitable separate robot movements can be planned for each of them.

In the example described here, every variant of the workpiece is formed by a number of specific local geometric forms of a base body, whereas the different geometric forms can be created by add-on components arranged on the base body of the workpiece (cf. FIGS. 9-11) or by modifying the outer geometric form of the workpiece base body (cf. FIG. 12). For example, the first virtual workpiece may comprise a superposition of a first number of geometric forms in the first region and a superposition of a second number of geometric forms in the second region. The same applies for the second (and for every further) virtual workpiece. In particular, the geometric forms in the various regions of the workpiece for which tool paths are to be planned may turn out to be mutually exclusive when the workpiece is actually implemented. Thus a virtual workpiece cannot be realized because, for example, two different add-on components overlap (cf. FIG. 9).

Techniques for planning and verifying tool paths are widely known. Verifying the determined tool paths may comprise, e.g. the following: simulating the movement of the tool along the planned tool path and testing in the simulation whether a collision-free movement of the tool is possible, as well as (additionally or alternatively) simulating the processing results obtained by the tool as it is moved and testing in the simulation whether the results fulfill a specified criterion (e.g. a sufficient thickness of the paint applied in a painting process). Simulating the movement of a tool along the planned tool paths generally only takes into consideration the movement of the tool and not the movement of the robot that moves the tool. When planning the tool paths for the first region of the workpiece, the largest number of geometric forms (e.g. of add-on components) possible is considered in the simulation (at best, all of the geometric forms) in the second region of the workpiece, whereas in the second region (only) those geometric forms are left unconsidered for which the verification revealed a collision risk or the non-fulfillment of a specified criterion. Thus, all of the workpiece variants for which the simulations reveal that the tool paths cannot be followed (because of a possible collision) or that the processing (e.g. painting) does not produce the desired results are removed from the first virtual workpiece. For all of the workpiece variants remaining in the first virtual workpiece, the planned tool paths can be followed (collision free) and the processing produces the desired results.

Based on the determined tool paths, the robot movements (in time and space) can be determined. Accordingly, the robot movements that are suitable for following the determined tool paths in the first region of the workpiece with a tool are determined with the aid of a computer. This includes verifying the determined robot movements using simulations based on the first virtual workpiece or on a further, modified version thereof. Afterwards a robot program is automatically generated that represents the verified robot movements. Software tools for automatically determining the robot movement for the given tool path, including the intermediate movements of the robot (from the end point of one path to the starting point of the next path), are generally known. By following the example here, however, for this purpose a different virtual workpiece can be used than the one used for the path planning itself. For example, the first virtual workpiece (that was used for planning the paths in the first region) can be modified to determine the robot movements by removing those workpiece variants from the virtual workpiece that have local geometric forms in the second region for which the simulation of the robot movements (not to be confused with the simulation of the tool movement along the tool path) reveals a risk of collision. The modified virtual workpiece can be (gradually) further modified by removing those workpiece variants from the modified virtual workpiece that have local geometric forms in the first or second region for which the simulation of the robot movements reveal a risk of collision (with the robot).

In accordance with one example, the first and second regions are located in one segment of the workpiece that is to be processed in one step and for which integrated robot movements are to be planned. In this case the method may comprise generating a modified virtual workpiece that comprises at least some, at best all, of the workpiece variants contained both in the first virtual workpiece, as well as in the second virtual workpiece (intersecting set of the workpiece variants). Afterwards, the robot movements that are suitable for following the determined paths in that segment of the workpiece can be automatically determined using the software tool. This includes verifying the determined robot movements by means of simulation based on the modified virtual workpiece. The determined robot movements, or a robot program derived therefrom, are (is) assigned to the workpiece variants contained in the modified virtual workpiece and can be selected during production for the processing of a specific variant.

A further embodiment relates to a system for the computer-aided programming of robots for the processing of workpieces. The system comprises a workstation with at least one processor, as well as a software tool run on the at least one processor of the workstation, the software tool being programmed to: generate various virtual workpieces, wherein models of numerous individual workpieces are superposed, and to verify tool paths for the processing of different regions of the workpiece using simulations, wherein different virtual workpieces are used for different regions of the workpiece. The software tool can be further programmed to determine robot movements that are suitable to follow the determined tool paths in a first region with a tool, to verify the determined robot movements using simulations based on a first virtual workpiece that was also used to verify the tool paths of the first region or based on a modified virtual workpiece, and to generate a robot program that represents the verified robot movements.

1-15. (canceled)

16. A method for computer-aided programming of robots for processing of workpieces, the method comprising:
generating a first virtual workpiece by virtually superposing models of numerous workpiece variants of a workpiece using a software tool run on a workstation;
carrying out a path planning to determine tool paths for at least one first region of the workpiece and verifying the determined tool paths based on the first virtual workpiece;
generating a second virtual workpiece by virtually superposing models of numerous workpiece variants of the workpiece using a software tool run on a workstation, wherein the first virtual workpiece does not comprise the same number of superposed workpiece variants as the second virtual workpiece; and
carrying out a path planning to determine tool paths for at least one second region of the workpiece and verifying the determined tool paths based on the second virtual workpiece.

17. The method of claim 16, wherein each of the workpiece variants comprises a number of specific local geometric forms of a base body.

18. The method of claim 17, wherein the specific local geometric forms are created by add-on components arranged on the workpiece base body or by modifying an outer geometric form of the workpiece base body.

19. The method of claim 16, wherein the first virtual workpiece comprises a superposition of a first number of geometric forms in the first region and a superposition of a second number of geometric forms in the second region, wherein the second virtual workpiece comprises a superposition of a third number of geometric forms in the first region and a superposition of a fourth number of geometric forms in the second region, and wherein the geometric forms in the first region and/or in the second region may be mutually exclusive in an actual implementation of the workpiece.

20. The method of claim 16, wherein verifying the determined tool paths comprises:
simulating a movement of a tool along planned tool paths and, based on the simulation, testing whether the simulated movement of the tool is possible without collision; and/or
simulating the processing results obtained by the tool while the tool is being moved and, based on the simulation, testing whether the results fulfill a specified criterion.

21. The method of claim 20, wherein only the movement of the tool and not movement of a robot that moves the tool is considered when simulating the movement of the tool along the planned tool paths.

22. The method of claim 20, wherein for the path planning in the first region, the second number of geometric forms in the second region that are considered in the simulation is as large as possible, whereby, in the second region, those geometric forms are not considered for which the verification reveals a collision risk or the non-fulfillment of the specified criterion.

23. The method of claim 16, further comprising:
computer-aided determining of robot movements that are suitable for following with a tool the tool paths determined in the first region;
verifying the determined robot movements by simulation based on the first virtual workpiece or on a further modified first virtual workpiece; and
automatically generating a robot program representing the verified robot movements.

24. The method of claim 23, wherein the first virtual workpiece is modified by removing those workpiece variants from the virtual workpiece that have local geometric forms in the second region for which the simulation of the robot movements reveal a risk of collision.

25. The method of claim 23, wherein the first and the second regions are located in a segment of the workpiece, the method further comprising:
generating a modified virtual workpiece that includes at least some of the workpiece variants contained both in the first virtual workpiece and in the second virtual workpiece;
computer-aided determining of robot movements that are suitable for following the determined tool paths in the segment of the workpiece; and
verifying the determined robot movements by means of simulation based on the modified virtual workpiece.

26. The method of claim 24, wherein the modified virtual workpiece is further modified by removing those workpiece variants from the modified virtual workpiece that have local geometric forms in the first or second region for which the simulation of the robot movements reveals a collision risk.

27. The method of claim 24, further comprising:
assigning the determined robot movements or a robot program derived therefrom to the workpiece variants contained in the modified virtual workpiece.

28. A computer program product comprising a non-transitory computer readable medium storing a computer program operable for computer-aided programming of robots for processing of workpieces, the computer program comprising:
program instructions to generate a first virtual workpiece by virtually superposing models of numerous workpiece variants of a workpiece using a software tool run on a workstation;
program instructions to carry out a path planning to determine tool paths for at least one first region of the workpiece and verifying the determined tool paths based on the first virtual workpiece;
program instructions to generate a second virtual workpiece by virtually superposing models of numerous workpiece variants of the workpiece using a software tool run on a workstation, wherein the first virtual workpiece does not comprise the same number of superposed workpiece variants as the second virtual workpiece; and
program instructions to carry out a path planning to determine tool paths for at least one second region of the workpiece and verifying the determined tool paths based on the second virtual workpiece.

29. A system for the computer-aided programming of robots for the processing of workpieces; the system comprising:
a workstation with at least one processor;
a software tool run by the at least one processor of the workstation, the software tool being programmed to:
generate various virtual workpieces, wherein models of numerous workpiece variants of a workpiece are virtually superposed; and
verify in simulations tool paths for the processing of different regions of the workpiece, wherein different virtual workpieces are used for different regions of the workpiece.

30. The system of claim 29, wherein the software tool is further programmed to:
determine robot movements that are suitable for following with a tool the determined tool paths in the first region of the workpiece;
verify the determined robot movements by means of simulation based on a first virtual workpiece that was also used for the verification of the tool paths of the first region or based on a modified virtual workpiece; and
generating a robot program that represents the verified robot movements.
